(19) United States
(12) Patent Application Publication
(10) Pub. No.: US 2009/0124203 A1
(43) Pub. Date: May 14, 2009

(54) Apparatus and method for extracting second harmonic signal

(75) Inventors: Tai-Kyong Song, Seoul (KR); Sang-Min Kim, Seoul (KR); Jae-Hee Song, Seoul (KR)

Correspondence Address: THE NATH LAW GROUP, 112 South West Street, Alexandria, VA, 22314, US

(73) Assignee: INDUSTRY-UNIVERSITY COOPERATION FOUNDATION SOGANG UNIVERSITY, Seoul (KR)

(21) Appl. No.: 12/292,076

(22) Filed: Nov. 12, 2008

(30) Foreign Application Priority Data
Nov. 13, 2007 (KR) 10-2007-0115252

(51) Int. Cl. H04B 7/00

(52) U.S. Cl. 455/42

(57) ABSTRACT

Disclosed herein is an apparatus and method for extracting a second harmonic signal. The apparatus removes a fundamental frequency signal from a reception signal and then extracting the second harmonic signal. A transmitter generates a transmission signal by modulating a reference signal, and then transmits the transmission signal. A receiver extracts the second harmonic components of the reception signal by demodulating the reception signal received after the transmission signal is reflected by an external media. The transmitter includes a reference signal input unit, a first phase modulation unit, a second phase modulation unit, and a transmission signal output unit. The receiver includes a reception signal input unit, a first output signal generation unit, a second output signal generation unit, and a signal output unit.

### CROSS-REFERENCE TO RELATED PATENT APPLICATION

This application claims the benefit of Korean Patent Application No. 10-2007-0115252, filed on Nov. 13, 2007, in the Korean Intellectual Property Office, the disclosure of which is incorporated herein in its entirety by reference.

### BACKGROUND OF THE INVENTION

1. Field of the Invention

The present invention relates generally to an apparatus and method for extracting a second harmonic signal, and, more particularly, to an apparatus and method for extracting a second harmonic signal, which removes a reference frequency signal and then extracts only a second harmonic signal from a received and focused signal through a single transmission/reception process and provides the second harmonic signal.

2. Description of the Related Art

Harmonic imaging technique is a technique for imaging by extracting only harmonic components from a reception signal. It generates a higher image resolution than the method of using a fundamental frequency, so that the harmonic imaging technique has been used to employ a contrast medium or used to image the characteristics of a pattern. A method using a filter and a pulse inversion method correspond to the most frequently used harmonic imaging method.

The method using a filter is a method of extracting harmonic components from a received and focused signal using a band pass filer, and has a problem in that the bandwidth of a transmission signal is limited such that the spectrum of fundamental frequency components is not overlapped with the spectrum of harmonic components. The pulse inversion method is a method of removing fundamental frequency components and causing only harmonic components to remain by performing a transmission/reception process twice using two transmission pulses, the phase difference therebetween is 180 degree. Although the bandwidth of a transmission signal is not limited, the transmission/reception process is required to be performed twice, so that there is a disadvantage in that the frame rate is reduced to ½, compared to the case in which the transmission/reception process is performed once, and also there is a problem in that motion artifacts occur.

Therefore, the present applicant proposes a method of solving the disadvantage of the pulse inversion method and one capable of extracting harmonic components through a once transmission/reception process.

### SUMMARY OF THE INVENTION

Accordingly, the present invention has been made keeping in mind the above problems occurring in the prior art, and an object of the present invention is to provide an apparatus and method for extracting a second harmonic signal, which removes a reference frequency signal from a reception signal, and then extracts and provides only a second harmonic signal through a single transmission/reception process.

In order to accomplish the object, the present invention provides an apparatus for extracting a second harmonic signal, the apparatus removing a fundamental frequency signal from a reception signal and then extracting the second harmonic signal, the apparatus including a transmitter for generating a transmission signal by modulating a reference signal, and then transmitting the transmission signal; and a receiver for extracting the second harmonic components of the reception signal by demodulating the reception signal received after the transmission signal is reflected by an external media; wherein the transmitter includes a reference signal input unit for simultaneously outputting the received reference signal and a reference signal, the phase of which has been modulated by 180 degrees; a first phase modulation unit for receiving the reference signal from the reference signal input unit, and outputting a first transmission signal generated by modulating the phase of the reference signal using a first modulation signal; a second phase modulation unit for receiving the reference signal, the phase of which has been modulated by 180 degrees, from the reference signal input unit, and then outputting a second transmission signal generated by modulating the phase of the reference signal, the phase of which has been modulated by 180 degrees, using a second modulation signal; and a transmission signal output unit for outputting the transmission signal generated by combining the first transmission signal with the second transmission signal; and wherein the receiver includes: a reception signal input unit for receiving the reception signal from an outside; a first output signal generation unit for outputting a first output signal generated by modulating the phase of the reception signal using a third modulation signal; a second output signal generation unit for outputting a second output signal generated by modulating the phase of the reception signal using a fourth modulation signal; and a signal output unit for outputting an output signal generated by combining the first output signal with the second output signal.

Here, the first modulation signal and the second modulation signal are set such that a phase difference therebetween is any of all degrees except for 0 and 180 degrees. Preferably, the first modulation signal can be set to cos(2πf₀t), and the second modulation signal can be set to cos(2πf₀t+α). The first output signal generation unit of the apparatus for extracting a second harmonic signal generates a first output signal by multiplying the reception signal by a third modulation signal, and the second output signal generation unit generates a second output signal by multiplying the reception signal by a fourth modulation signal. The third modulation signal is exp(−j2πf₀t) and the fourth modulation signal is exp(−j2πf₀t−jα). Here, α is phase difference between the first modulation signal and the second modulation signal, and is an arbitrary value corresponding to any of all degrees expect for 0 and 180 degrees.

A method of extracting a second harmonic signal according to another aspect of the present invention relates to a method of extracting a second harmonic signal using a device including a receiver and a transmitter, the method including the steps of (a) outputting a transmission signal generated by modulating a reference signal; and (b) extracting a second harmonic signal from the reception signal; wherein step (a) includes: (a1) generating a first transmission signal by modulating the phase of the reference signal by 90 degrees; (a2) generating a second transmission signal by modulating the phase of the reference signal, the phase of which has been modulated by 180 degrees, by 90 degrees; and (a3) outputting the transmission signal by combining the first transmission signal with the second transmission signal; and wherein step (b) includes: (b1) generating a first output signal by modulating the phase of the reception signal received from an outside; (b2) generating a second output signal by modulating the phase of the reception signal so that a phase difference between the first output signal and the second output signal is 90 degrees; (b3) generating an output signal by combining the first output signal with the second output signal; and (b4) removing an out-band signal from the output signal using a low-pass filter.

The step (a1) includes generating the first transmission signal by multiplying the reference signal by a first modulation signal; and the step (a2) includes generating the second transmission signal by multiplying the reference signal, the phase of which has been modulated by 180 degrees, by a second modulation signal. The phase difference between the first modulation signal and the second modulation signal is an arbitrary value corresponding to any of all degrees expect for 0 and 180 degrees. Preferably, the first modulation signal is cos(2πf₀t); and the second modulation signal is cos(2πf₀t+α). The step (b1) includes generating the first output signal by multiplying the reception signal by a third modulation signal; and the step (b2) includes generating the second output signal by multiplying the reception signal by a fourth modulation signal. Preferably, the first modulation signal is exp(−j2πf₀t); and the second modulation signal is exp(−j2πf₀t−jα).

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram schematically showing the transmitter of an apparatus for extracting a second harmonic signal according to a preferred embodiment of the present invention; and

FIG. 2 is a block diagram schematically showing the receiver of an apparatus for extracting a second harmonic signal according to a preferred embodiment of the present invention.

### DESCRIPTION OF THE PREFERRED EMBODIMENTS

Reference now should be made to the drawings, in which the same reference numerals are used throughout the different drawings to designate the same or similar components.

Hereinafter, an apparatus and method for extracting a second harmonic signal according to a preferred embodiment of the present invention will be described in detail with reference to the attached drawings.

The apparatus for extracting a second harmonic signal according to a preferred embodiment of the present invention includes a transmitter for outputting a transmission signal, and a receiver for extracting a second harmonic signal from a reception signal received from the outside.

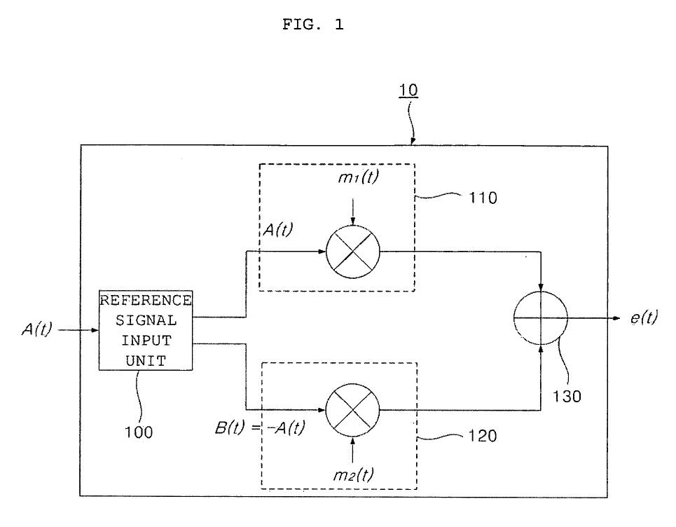

FIG. 1 is a block diagram schematically showing the transmitter of the apparatus for extracting a second harmonic signal according to a preferred embodiment of the present invention. Referring to FIG. 1, the transmitter 10 is configured to generate and transmit a transmission signal e(t) by modulating a reference signal A(t), and configured to include a reference signal input unit 100, a first phase modulation unit 110, a second phase modulation unit 120, and a transmission signal output unit 130. The reference signal input unit 100 receives the reference signal A(t) from the outside, provides the received reference signal to the first phase modulation unit 110, and, at the same time, modulates the phase of the reference signal by 180 degrees and then provides the resulting reference signal to the second phase modulation unit 120. The first phase modulation unit 110 generates a first transmission signal by modulating the phase of the reference signal by 90 degrees, and then provides the first transmission signal to the transmission signal output unit. The first phase modulation unit generates the first transmission signal by multiplying the reference signal by cos(2πf₀t), which is a first modulation signal m₁(t). The second phase modulation unit 120 generates a second transmission signal by modulating the phase of the reference signal B(t)=−A(t), the phase of which has been modulated by 180 degrees, by 90 degrees, and then provides the second transmission signal to the transmission signal output unit.

The second phase modulation unit 120 generates the second transmission signal by multiplying the reference signal, the phase of which has been modulated by 180 degrees, by cos(2πf₀t+α), which is the second modulation signal m₂(t). It is preferable that setting be made such that the phase difference α between the first modulation signal and the second modulation signal is any of all degrees expect for 0 and 180 degrees. The transmission signal output unit 130 outputs the transmission signal e(t) generated by combining the first transmission signal with the second transmission signal. Therefore, the transmission signal e(t) can be expressed as the following Equation 1, and can be generalized as the following Equation 2:

e(t)=A(t)cos(2πf_{c}t)+B(t)sin(2πf_{c}t) (1)

e(t)=A(t)cos(2πf_{c}t)+B(t)cos(2πf_{c}t+α) (2)

where α is an arbitrary phase value and, if α=π/2, the value acquired using Equation 2 is the same as the value acquired using Equation 1. Equation 2 can be expressed as the following Equation 3 using Euler formula:

$$e ( t ) = A ( t ) \{ \begin{matrix}exp ( j 2 π {f}_{c} t ) + \\ exp ( - j 2 π {f}_{c} t )\end{matrix} \} + B ( t ) \{ \begin{matrix}exp ( j ( 2 π {f}_{c} t + α ) ) + \\ exp ( - j 2 π {f}_{c} t + α ) )\end{matrix} \} \qquad ( 3 )$$

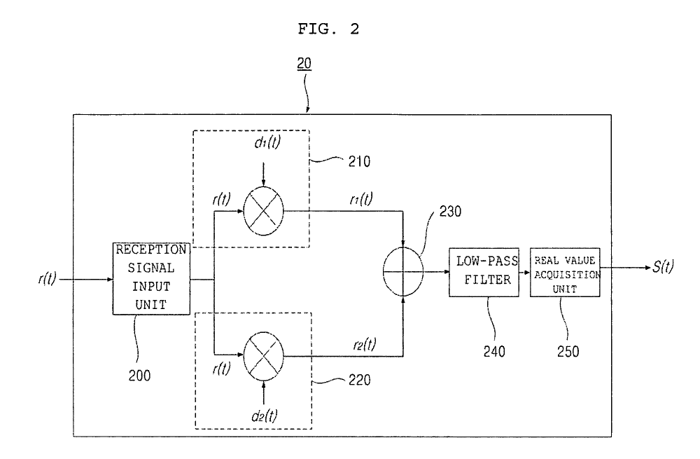

FIG. 2 is a block diagram schematically showing the receiver of the apparatus for extracting a second harmonic signal according to a preferred embodiment of the present invention. Referring to FIG. 2, a receiver 20 is configured to extract a second harmonic signal from a reception signal r(t) received after the transmission signal e(t) is reflected from an outside non-linear media, and configured to include a reception signal input unit 200, a first output signal generation unit 210, a second output signal generation unit 220, a signal output unit 230, a low-pass filter 240, and a real value acquisition unit 250. The reception signal input unit 200 receives the reception signal r(t) from the outside, and then provides the received signal to the first output signal generation unit and the second output signal generation unit. The reception signal is a signal in which the transmission signal e(t) is reflected from a non-linear medium, and can be approximated as the polynomial function of the following Equation 4:

O(e(t))=a₁e(t)+a₂e(t)²+a₃e(t)³+K+a_{N}e(t)^{N} (4)

where N is a value which means N-th harmonic, and, in the present invention, it is assumed that harmonic components to the extent of second harmonic components, in which N=2, are received in consideration of the characteristics of an ultrasonic converter. Therefore, the reception signal r(t) can be expressed as the following Equation 5 by substituting Equation 3 for Equation 4:

$$r ( t ) = {a}_{1} [ \begin{matrix}A ( t ) \{ \begin{matrix}exp ( j 2 π {f}_{c} t ) + \\ exp ( - j2 π {f}_{c} t )\end{matrix} ] + \\ B ( t ) \{ \begin{matrix}exp ( j ( 2 π {f}_{c} t + α ) ) + \\ exp ( - j ( 2 π {f}_{c} t + α ) )\end{matrix} \}\end{matrix} ] + {a}_{2} [ \begin{matrix}{A}^{2} ( t ) \{ \begin{matrix}exp ( j 2 π ( 2 {f}_{c} ) t ) + \\ exp ( - j 2 π ( 2 {f}_{c} ) t )\end{matrix} \} + \\ A ( t ) B ( t ) \{ \begin{matrix}exp ( j ( 2 π ( 2 {f}_{c} ) t + α ) ) + \\ exp ( - j ( 2 π ( 2 {f}_{c} ) t + α ) )\end{matrix} \} + \\ {B}^{2} ( t ) \{ \begin{matrix}exp ( j ( 2 π ( 2 {f}_{c} ) t + 2 α ) ) + \\ exp ( - j ( 2 π ( 2 {f}_{c} ) t + 2 α ) )\end{matrix} \}\end{matrix} ] \qquad ( 5 )$$

The first output signal generation unit 210 generates a first output signal r₁(t) by modulating the phase of the reception signal, and then provides the first output signal r₁(t) to the signal output unit. The first output signal generation unit 210 generates the first output signal by multiplying the reception signal r(t) by exp(−j2πf₀t), that is, a third modulation signal d₁(t). The first output signal r₁(t) can be expressed as the following Equation 6:

$$\begin{matrix}{r}_{1} ( t ) = r ( t ) \cdot exp ( - j 2 π {f}_{c} t ) \\ = {a}_{1} [ \begin{matrix}A ( t ) \{ 1 + exp ( - j 2 π ( 2 {f}_{c} ) t ) \} + \\ B ( t ) \{ exp ( jα ) + exp ( - j ( 2 π ( 2 {f}_{c} ) t + α ) ) \}\end{matrix} ] + \\ {a}_{2} [ \begin{matrix}{A}^{2} ( t ) \{ exp ( j 2 π ( 2 {f}_{c} ) t ) + exp ( - j2 π ( 3 {f}_{c} ) t ) \} + A ( t ) B ( t ) \\ \{ exp ( j ( 2 π {f}_{c} t + α ) ) + exp ( - j ( 2 π ( 3 {f}_{c} ) t + 2 α ) ) \} + \\ {B}^{2} ( t ) \{ exp ( j ( 2 π {f}_{c} t + 2 α ) ) + exp ( - j ( 2 π ( 3 {f}_{c} ) t + 2 α ) ) \}\end{matrix} ]\end{matrix} \qquad ( 6 )$$

The second output signal generation unit 220 generates a second output signal r₂(t) by modulating the phase of the reception signal, and then provides the second output signal r₂(t) to the signal output unit. Here, it is characterized in that the phase difference α between the second output signal and the first output signal is any of all degrees except for 0 and 180 degrees. The phase difference α is the same as the phase difference between the first modulation signal and the second modulation signal. The second output signal generation unit 220 generates the second output signal by multiplying the reception signal r(t) by exp(−j2πf₀t−jα), that is, a fourth modulation signal d₂(t). The second output signal r₂(t) can be expressed as Equation 7. It is preferable that setting be made such that the phase difference between the third modulation signal and the fourth modulation signal is the same as the phase difference between the first modulation signal and the second modulation signal. Although the third modulation signal d₁(t) is set to exp(−j2πf₀t) and the fourth modulation signal d₂(t) is set to exp(−j2πf₀t−jα) in the present embodiment, the scope of the present patent is not limited thereto.

$$\begin{matrix}{r}_{2} ( t ) = r ( t ) \cdot exp ( - j 2 π {f}_{c} t + α ) \\ = {a}_{1} [ \begin{matrix}A ( t ) \{ exp ( - j α ) + exp ( - j ( 2 π ( 2 {f}_{c} ) t + α ) ) \} + \\ B ( t ) \{ 1 + exp ( - j ( 2 π ( 2 {f}_{c} ) t + 2 α ) ) \}\end{matrix} ] + \\ {a}_{2} [ \begin{matrix}{A}^{2} ( t ) \{ \begin{matrix}exp ( j 2 π ( 2 {f}_{c} ) t - α ) + \\ exp ( - j ( 2 π ( 3 {f}_{c} ) t + α ) )\end{matrix} \} + A ( t ) B ( t ) \\ \{ exp ( j 2 π {f}_{c} t ) + exp ( - j ( 2 π ( 3 {f}_{c} ) t + 2 α ) ) \} + \\ {B}^{2} ( t ) \{ exp ( j ( 2 π {f}_{c} t + α ) ) + exp ( - j ( 2 π ( 3 {f}_{c} ) t + 3 α ) ) \}\end{matrix} ]\end{matrix} \qquad ( 7 )$$

The signal output unit 230 outputs an output signal generated by combining the first output signal r₁(t) with the second output signal r₂(t). The low-pass filter 240 is configured to be connected to the output terminal of the signal output unit, and to remove noise and out-band signals by removing the out-band signals from the output signal of the signal output unit. In Equation 6 and Equation 7, components, each of center frequency of which is 2f_{c} or 3f_{c}, are removed by the low-pass filter 240. Therefore, a final output signal S(t) output from the low-pass filter is acquired by adding f_{c} components of respective Equation 6 and Equation 7, and, if B(t)=−A(t), S(t) can be expressed as the following Equation 8:

$$S ( t ) = {a}_{1} [ A ( t ) exp ( - j α ) - A ( t ) exp ( j α ) ] + {a}_{2} [ \begin{matrix}{A}^{2} ( t ) exp ( j ( 2 π {f}_{c} t - α ) ) + \\ {A}^{2} ( t ) exp ( j ( 2 π {f}_{c} t + 2 α ) )\end{matrix} ] \qquad ( 8 )$$

The real value acquisition unit acquires and outputs only real values from the output signal S(t) from the low-pass filter 240. Equation 8 can be expressed as the following Equation 9 by dividing into real components and imaginary components.

$$S ( t ) = {a}_{1} [ - 2 A ( t ) j sin α ] + {a}_{2} [ \begin{matrix}{A}^{2} ( t ) \{ \begin{matrix}cos ( 2 π {f}_{c} t - α ) + \\ cos ( 2 π {f}_{c} t + 2 α )\end{matrix} \} \\ j {A}^{2} ( t ) \{ \begin{matrix}sin ( 2 π {f}_{c} t - α ) + \\ sin ( 2 π {f}_{c} t + 2 α )\end{matrix} \}\end{matrix} ] \qquad ( 9 )$$

The results, in which only real components are acquired using Equation 9, are expressed as the following Equation 10:

$$S ( t ) = {a}_{2} \cdot {A}^{2} ( t ) \{ \begin{matrix}cos ( 2 π {f}_{c} t - α ) + \\ cos ( 2 π {f}_{c} t + 2 α )\end{matrix} \} \qquad ( 10 )$$

Based on Equation 10, it can be seen that the apparatus for extracting a second harmonic signal according to the present invention removes fundamental frequency components. However, if α=0, the transmission signal e(t) is 0 based on Equation 2, and, if α=π the final output S(t) is 0 based on Equation 10. Therefore, in all the cases except for the above two cases, the output of the apparatus for extracting a second harmonic signal according to the present invention appears in the form in which the fundamental frequency components are completely removed, and only the envelope components of the second harmonic signal, that is, α₂A²(t), appear in modulated forms in the sine wave signal of the center frequency. Therefore, only the second harmonic components can be imaged by extracting this signal. The apparatus for extracting a second harmonic signal having the above-described configuration according to the present invention combines two signals into a single signal through quadrature amplitude modulation, transmits the resulting signal, divides the signal into the two original signals based on the reception signal through a signal processing process, and then applies a pulse conversion technique, so that fundamental frequency components of the signal are removed and then second harmonic components can be acquired. The apparatus and method according to the present invention relates to an apparatus which allows the harmonic components of a received and focused signal to be extracted, and can be widely used in an ultrasound imaging method using a contrast medium or an ultrasound molecular imaging field for imaging the characteristics of a pattern.

According to the present invention, unlike the conventional technique that requires a transmission/reception process to be performed twice, a fundamental frequency signal can be removed from a reception signal, and a second harmonic signal can be extracted through a single signal transmission/reception process. Therefore, the present invention can acquire second harmonic components through a single transmission/reception process in the state in which the fundamental frequency components are overlapped with the second harmonic components in a frequency area, so that the frame rate is two times higher than that of the conventional pulse inversion method that requires the transmission/reception process to be performed twice, and further so that motion artifacts can be reduced. Therefore, the method according to the present invention can improve the image quality of a method using pattern imaging and an ultrasound imaging method using a contrast medium, and, in particular, can be efficiently used for the harmonic images of a reflector which move very fast.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for extracting a second harmonic signal, the apparatus removing a fundamental frequency signal from a reception signal and then extracting the second harmonic signal, the apparatus comprising:
a transmitter for generating a transmission signal by modulating a reference signal, and then transmitting the transmission signal; and
a receiver for extracting second harmonic components of the reception signal by demodulating the reception signal received after the transmission signal is reflected by an external media;
wherein the transmitter comprises:
a reference signal input unit for simultaneously outputting the received reference signal A(t) and a reference signal −A(t), a phase of which has been modulated by 180 degrees;
a first phase modulation unit for receiving the reference signal A(t) from the reference signal input unit, and outputting a first transmission signal generated by modulating the phase of the reference signal using a first modulation signal;
a second phase modulation unit for receiving the reference signal −A(t), the phase of which has been modulated by 180 degrees, from the reference signal input unit, and then outputting a second transmission signal generated by modulating the phase of the reference signal, the phase of which has been modulated by 180 degrees, using a second modulation signal; and
a transmission signal output unit for outputting the transmission signal generated by combining the first transmission signal with the second transmission signal; and
wherein the receiver comprises:
a reception signal input unit for receiving the reception signal from an outside;
a first output signal generation unit for outputting a first output signal generated by modulating a phase of the reception signal using a third modulation signal;
a second output signal generation unit for outputting a second output signal generated by modulating the phase of the reception signal using a fourth modulation signal; and
a signal output unit for outputting an output signal generated by combining the first output signal with the second output signal.

2. The apparatus as set forth in claim 1, wherein the first modulation signal and the second modulation signal are set such that a phase difference therebetween is any of all degrees except for 0 and 180 degrees.

3. The apparatus as set forth in claim 1, wherein the third modulation signal and the fourth modulation signal are set such that a phase difference therebetween is any of all degrees except for 0 and 180 degrees, and the phase difference is set to a value equal to a phase difference between the first modulation signal and the second modulation signal.

4. The apparatus as set forth in claim 1, wherein the receiver further comprises a low-pass filter configured to be connected to an output terminal of the signal output unit and to remove an out-band noise signal.

5. The apparatus as set forth in claim 4, wherein the receiver further comprises a real value acquisition unit configured to be connected to an output terminal of the low-pass filter and to acquire and output only a real value from the low-pass filter.

6. A method of extracting a second harmonic signal, the method removing a fundamental frequency signal from a reception signal and then extracting the second harmonic signal using a device including a receiver and a transmitter, the method comprising the steps of:
(a) outputting a transmission signal generated by modulating a reference signal; and
(b) extracting a second harmonic signal from the reception signal;
wherein step (a) comprises:
(a1) generating a first transmission signal by modulating a phase of the reference signal by 90 degrees;
(a2) generating a second transmission signal by modulating the phase of the reference signal, the phase of which has been modulated by 180 degrees, by 90 degrees; and
(a3) outputting the transmission signal by combining the first transmission signal with the second transmission signal; and
wherein step (b) comprises:
(b1) generating a first output signal by modulating a phase of the reception signal received from an outside;
(b2) generating a second output signal by modulating the phase of the reception signal so that a phase difference between the first output signal and the second output signal is 90 degrees;
(b3) generating an output signal by combining the first output signal with the second output signal; and
(b4) removing an out-band signal from the output signal using a low-pass filter.

7. The method as set forth in claim 6, wherein:
step (a1) comprises generating the first transmission signal by multiplying the reference signal by a first modulation signal;
step (a2) comprises generating the second transmission signal by multiplying the reference signal, the phase of which has been modulated by 180 degrees, by a second modulation signal;
the first modulation signal is cos(2πf₀t); and
the second modulation signal is cos(2πf₀t+α).

8. The method as set forth in claim 6, wherein:
step (b1) comprises generating the first output signal by multiplying the reception signal by a third modulation signal;
step (b2) comprises generating the second output signal by multiplying the reception signal by a fourth modulation signal;
the first modulation signal is exp(−j2πf₀t); and
the second modulation signal is exp(−j2πf₀t−jα).
